(19) United States
(12) Patent Application Publication
(10) Pub. No.: US 2018/0209941 A1
(43) Pub. Date: Jul. 26, 2018

(54) DEVICE FOR DETECTING AND/OR MEASURING OUT AT LEAST ONE CHEMICAL COMPOUND, AND CHAMBER FOR FORMING SUCH A DEVICE

(71) Applicant: COMMISSARIAT A L'ENERGIE ATOMIQUE ET AUX ENERGIES ALTERNATIVES, Paris (FR)

(72) Inventors: Emmanuel SCORSONE, Magny-Les-Hameaux (FR); Bertrand BAZIN, Palaiseau (FR); Farbod GHASSEMI, Pantin (FR); Gaelle LISSORGUES, Le Perreux Sur Marne (FR); Rafa MANAI, Paris (FR); Krishna PERSAUD, Cheadle (GB); Lionel ROUSSEAU, Le Perreux Sur Marne (FR)

(73) Assignee: COMMISSARIAT A L'ENERGIE ATOMIQUE ET AUX ENERGIES ALTERNATIVES, Paris (FR)

(21) Appl. No.: 15/301,512

(22) PCT Filed: Apr. 2, 2015
(86) PCT No.: PCT/EP2015/057412

§ 371 Date: Oct. 3, 2016

(30) Foreign Application Priority Data
Apr. 4, 2014 (FR) 1453019

(51) Int. Cl. G01N 29/036; G01N 29/02

(52) U.S. Cl. CPC G01N 29/036; G01N 29/022; G01N 2291/028; G01N 2291/022; G01N 2291/106; G01N 2291/021

(57) ABSTRACT

A device for detecting and/or measuring out one or more chemical compounds and a cell for forming the device, the device including at least one first and one second vibrating surface, each having a resonance frequency which varies when placed in presence of at least one chemical compound to be detected, and at least one first system actuating the first and the second vibrating surface to vibrate the first vibrating surface. The first actuating system is configured to generate a first mechanical wave remote from the first and the second vibrating surface, the first actuating system arranged in the device such that the first mechanical wave is transmitted to the first and the second vibrating surfaces to vibrate the first and the second vibrating surfaces.

### TECHNICAL FIELD

The invention relates to the field of detecting and measuring out a chemical compound and in particular to devices for performing such detecting and/or measuring out using at least one vibrating surface as a transducer.

### STATE OF PRIOR ART

Among the detecting and/or measuring out devices, gravimetric type devices, in particular those implementing one or more vibrating surfaces as a transducer, generally enable sensitivities and selectivities higher than those obtained by other technologies to be reached.

Such detecting and/or measuring out devices include one or more vibrating surfaces, such as those formed by levers, preferentially functionalised so as to preferentially interact with one or more specific chemical compounds. Thus, upon placing in the presence of a vibrating surface with one of the corresponding specific chemical compounds, the interaction of the vibrating surface with this specific chemical compound modifies the resonance frequency of the latter by a modification in its physico-chemical characteristics such as its mass or its surface energy. A measurement of the resonance frequency of the vibrating surface thus enables the determination of whether the surface has been placed in the presence of said specific chemical compound and in which proportion.

To make such a measurement of the resonance frequency, such devices generally include, for each of the vibrating surfaces, a system for actuating the vibrating surface suitable for vibrating the vibrating surface and a system for measuring the vibration amplitude of the vibrating surface. These actuating systems can be of three different types: the capacitive actuating systems, the piezoelectric actuating systems, and the Laplace force actuating systems.

Regardless of the type of actuation systems employed, these actuating systems have to comprise an adaptation of the vibrating surface to be vibrated. Indeed, for capacitive actuating systems, the vibrating surface necessarily comprises a conductive zone so as to form an armature of a capacitor and an electrical connection to apply a bias voltage to the conductive zone. For piezoelectric actuating systems, the vibrating surface has to include both a piezoelectric zone formed of a piezoelectric material and an electrical connection to bias the piezoelectric zone. For Laplace force actuating systems, the vibrating surface has to include a conductive loop to generate a magnetic field when a current flows therethrough.

But, such adaptations modify the mechanical characteristics of the vibrating surfaces and thus can have a negative influence on the sensitivity of the detecting and/or measuring out devices equipped with such actuating systems. This is especially the case when the vibrating surfaces are made of diamond. Yet, the diamond is particularly interesting to use because, by virtue of its particular high Young modulus, it enables vibrating surfaces with particularly high resonance frequencies and quality factors to be provided, and thus relatively significant sensitivities to be reached.

Thus, regardless of the actuating system implemented, the adaptation of the vibrating surface made of diamond will necessarily induce a degradation in the mechanical properties and a lowering in the resonance frequency of the vibrating surface and hence a decrease in the sensitivity.

### DISCLOSURE OF THE INVENTION

One purpose of the invention is to overcome this drawback, in particular to provide a detecting and/or measuring out device which includes several vibrating surfaces and at least one actuating system, said actuating system having no influence on the mechanical characteristics of the vibrating surfaces and thus on their resonance frequency and allowing common calibration of the vibrating surfaces.

To that end, the invention relates to a device for detecting and/or measuring out one or more chemical compounds including:
at least one first and one second vibrating surface, each having a resonance frequency which varies when placed in the presence of at least one chemical compound to be detected,
at least one first system of actuating the first vibrating surface suitable for vibrating the first vibrating surface.

The first actuating system is suitable for generating a first mechanical wave remote from the first and the second vibrating surface, said first actuating system being arranged in said detecting and/or measuring out device such that the first mechanical wave is transmitted to the first vibrating surface so as to vibrate the first vibrating surfaces.

The use of such an actuating system enables the vibrating surface to be vibrated without requiring any adaptation of the latter unlike devices of prior art. As a result, the mechanical characteristics of the vibrating surface are preserved and thus the sensitivity is not altered.

It should be understood above and in the rest of this document by mechanical wave generated remote from a vibrating surface that the mechanical wave is generated at a non-zero distance from the vibrating surface. Such a characteristic should be understood as opposed to actuating systems of most of devices of prior art in which either the actuating system is integrated to the vibrating surface, such as a piezoelectric actuator integrated to a vibrating beam, either it enables the mechanical wave to be produced by generating a displacement of the vibrating surface on its own, such as a capacitive type actuator.

It will also be noted that such a device can also simpler to manufacture, since the actuating system is not necessarily integrated to a substrate of the vibrating surface and it can be macroscopic unlike actuating systems of prior art which necessarily include elements of the same order of magnitude as the vibrating surface, that is microscopic.

The device can include at least one second vibrating surface having a resonance frequency which varies when the second vibrating surface is placed in the presence of at least one chemical compound to be detected, the first actuating system being arranged for the first mechanical wave to be transmitted to the second surface so as to also vibrate the second vibrating surface.

In this manner, the device enables the same mechanical wave to be transmitted to the first and the second vibrating surface. Thus, it is possible to make a common calibration for the first and second vibrating surfaces.

The device can further include several systems for measuring the vibration amplitude of vibrating surface which are configured to measure the vibration amplitude of the first and the second vibrating surface.

The systems for measuring the vibration amplitude of vibrating surfaces can include strain gauges and optical systems such as laser vibrometers.

The arrangement of the first actuating system relative to the first and the second vibrating surface can be suitable for the power of the first mechanical wave transmitted to the first and the second vibrating surface to be substantially equal.

The device can include, according to a possibility which departs from the scope of the invention:
at least one second vibrating surface having a resonance frequency which varies when the second vibrating surface is placed in the presence of at least one chemical compound to be detected,
at least one second actuating system of the second vibrating surface suitable for vibrating the second vibrating surface, the second actuating system being suitable for generating a second mechanical wave remote from the second vibrating surface, said second actuating system being arranged in said device such that the second mechanical wave is transmitted to the second surface to vibrate it.

The device can include:
a cell in which a chemical composition comprising at least one chemical compound to be detected is likely to be introduced,
a substrate of vibrating surface disposed in said cell, said substrate comprising the first vibrating surface.

The cell can include the first actuating system.

The first actuating system can be a piezoelectric actuator.

The first vibrating surface can be made of diamond.

The invention further relates to a cell intended to be used in a device according to the invention and in which a chemical composition comprising at least one chemical compound to be detected is likely to be introduced, said cell including at least one location for accommodating a substrate of vibrating surface respectively including at least one first vibrating surface having a resonance frequency which varies when the first vibrating surface is placed in the presence of at least one chemical compound to be detected,

said cell further including at least one first actuating system suitable for generating a first mechanical wave remote from the location, said first actuating system being arranged in the cell such that the first mechanical wave is transmitted to the first vibrating surface so as to vibrate the first vibrating surfaces when the substrate of vibrating surface is accommodated in the location.

The invention further relates to a cell intended to be used in a device according to the invention, and in which a chemical composition comprising at least one chemical compound to be detected is likely to be introduced, said cell including at least one first and one second location for accommodating a first and a second substrate of vibrating surface respectively including a first and a second vibrating surface respectively, each having a resonance frequency which varies when placed in the presence of at least one chemical compound to be detected,

said cell further includes at least one first actuating system suitable for generating a first mechanical wave remote from the first and the second location, said first actuating system being arranged in the cell such that the first mechanical wave is transmitted to the first and the second vibrating surface so as to vibrate the first and the second vibrating surface when the first and the second substrate of vibrating surface are accommodated in the first and the second location.

By chemical composition, it is understood above and in the rest of this document a mixture of chemical compounds in fluidic form, that is in gaseous or solution form.

The device according to the invention can include:
a cell in which a chemical composition comprising at least one chemical compound to be detected is likely to be introduced,
at least one first and one second substrate of vibrating surface disposed in said cell, the first and the second substrate including the first and the second vibrating surface respectively.

The device according to the invention can include:
a cell in which a chemical composition comprising at least one chemical compound to be detected is likely to be introduced,
at least one substrate of vibrating surface disposed in said cell, said substrate including at least the first and the second vibrating surface.

### BRIEF DESCRIPTION OF DRAWINGS

The present invention will be better understood upon reading the description of exemplary embodiments, given by way of purely indicating and in no way limiting purposes, making reference to the appended drawings in which:

FIG. 1 illustrates an exemplary detecting and/or measuring out device according to the invention,

FIG. 2 is an exploded view of the device illustrated in FIG. 1,

FIGS. 3a and 3b respectively illustrate an exemplary vibrating surface of a device according to the invention including a strain gauge, and a principle of measurement of the strain gauge,

FIGS. 4a, b and c illustrate an exemplary cap for a device according to the invention in which the systems for measuring the vibration of the vibrating surfaces are strain gauges,

FIG. 5 illustrates an exemplary cap for a device according to the invention in which the measuring systems are optical ones.

Identical, similar or equivalent parts of the different figures bear the same reference numerals so as so facilitate switching from one figure to the other.

The different possibilities should be understood as not being exclusive of each other and can be combine to each other.

### DETAILED DISCLOSURE OF PARTICULAR EMBODIMENTS

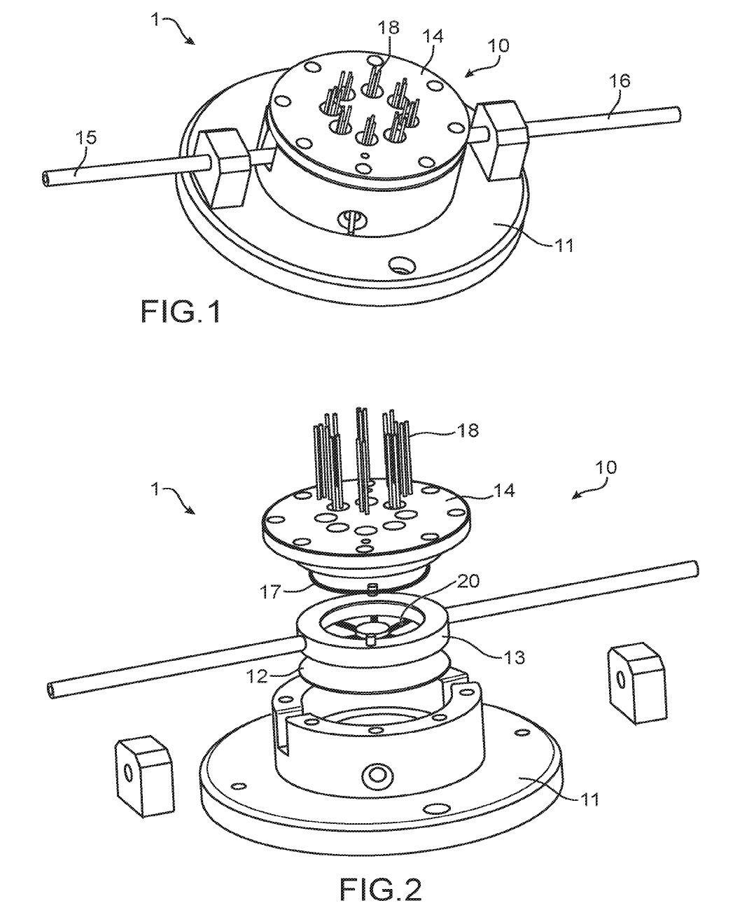

FIG. 1 illustrates a device 1 for detecting and/or measuring out at least one or more chemical compounds, in which a chemical compound, in a fluidic form, is likely to be introduced to detect and/or measure out at least one chemical compound thereof.

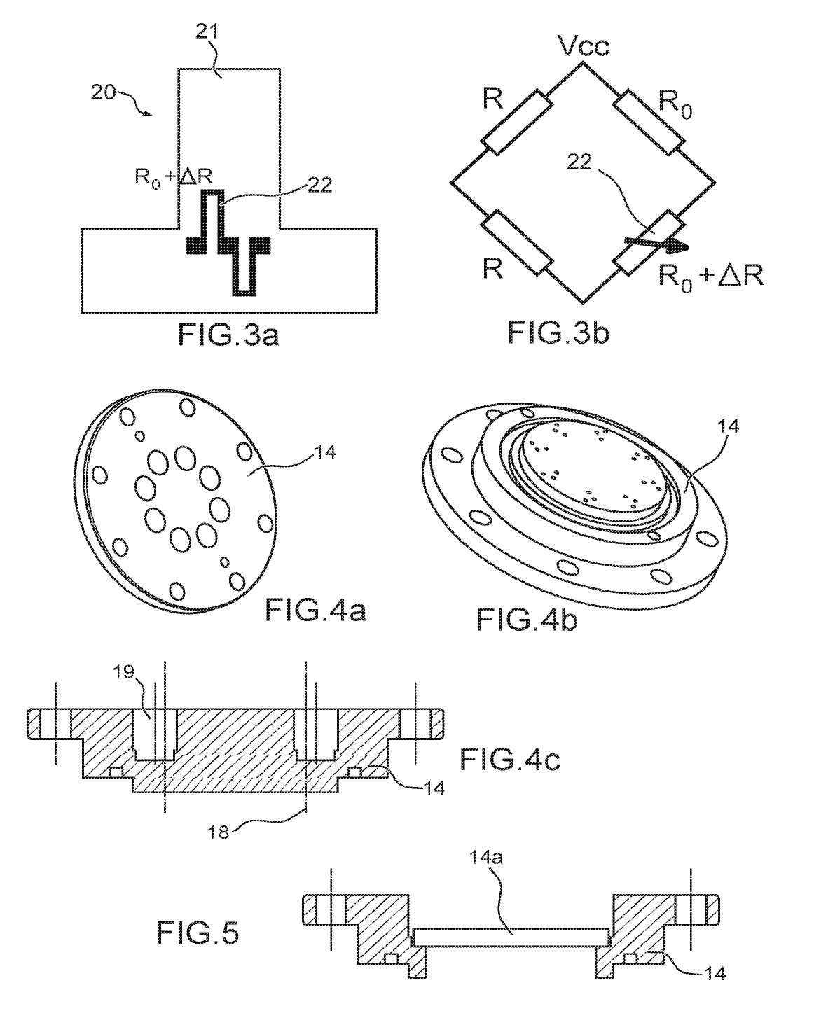

Such a device comprises, as illustrated on the exploded view of FIG. 2:
a cell 10 in which the chemical composition is intended to be introduced,
several substrates 20 of vibrating surfaces each including a vibrating surface 21, as illustrated in FIG. 3a.

The cell 10 includes, as illustrated in FIG. 2:
a base plate 11,
a piezoelectric actuator 12,
an analysis chamber 13 delimiting an analysis volume intended to contain the chemical composition,
a cap 14 intended to close the chamber 13,
a feed duct 15 intended to feed the chemical composition,
a removal duct 15 intended to remove the chemical composition after the analysis thereof.

The base plate 11 includes a base and a housing for accommodating the piezoelectric actuator 12 and the analysis chamber 13. The base plate 11 includes a through port for the electrical connection of the piezoelectric actuator 12.

The piezoelectric actuator 12 is a piezoelectric transducer suitable for generating a mechanical wave in a frequency range comprising the resonance frequencies of the vibrating surfaces 21. The piezoelectric actuator 12 has a circular shape so as to have an axial symmetry.

Alternatively to such a piezoelectric actuator, the cell can include another type of actuating system suitable for generating a mechanical wave such as for example an electromagnetic actuating system.

The analysis chamber 13 is disposed in the housing formed by the base plate 11 by being in mechanical contact with the piezoelectric actuator 12. The chamber has generally a cylindrical shape and includes an axis of symmetry. When the analysis chamber 13 and the piezoelectric actuator 12 are disposed in the housing of the base plate 11, the axes of symmetry of the analysis chamber 13 and of the piezoelectric actuator 12 are the same.

The internal surface of the analysis chamber 13 is preferentially neutral relative to the chemical compounds to be analysed, that is, it is suitable not to chemically or physically react with said chemical compounds. Such a neutrality of the internal surface of the analysis chamber 13 can be achieved either by the material of which the analysis chamber 13 is made, or by a suitable internal coating. Thus, the analysis chamber 13 can be made for example, as a function of the type of chemical compositions to be analysed, of stainless steel, polytetrafluoroethylene (better known as PTFE), polyetheretherketone (better known as PEEK), or even glass. Likewise, the analysis chamber 13 can also include, as a function of the chemical compounds to be analysed and their shape, a coating of one of the same materials.

The analysis chamber 13 includes locations each suitable for accommodating a substrate 20 of vibrating surfaces. The locations of the substrates 20 are distributed substantially equidistantly in the chamber with respect to the axis of symmetry of the analysis chamber 13. The locations of the substrates 20 are arranged in the analysis chamber 13 such that a substrate 10 disposed on one of the locations is in mechanical contact with the analysis chamber.

FIG. 3a illustrates an exemplary substrate 20 of vibrating surface in which the vibrating surface 21 is a micrometric lever and in which a strain gauge 22 integrated to the lever base is provided for measuring the vibration amplitude of the lever.

Such a strain gauge 22, known in prior art, is a resistive dipole the resistance of which varies with the stress applied thereto. Such a gauge integrated to the base of the lever thus has its resistance varied as a function of the vibration amplitude of the lever. Thus, by placing the strain gauge 22 in a Wheatstone bridge 25, as illustrated in FIG. 3b, it is possible to obtain an accurate measurement of the vibration amplitude of the lever.

Each strain gauge 22 forms a system for measuring the vibration amplitude of the corresponding vibrating surface 21.

Alternatively to such a strain gauge 22, it is also possible that the measurement of the vibration amplitude of a lever is made in the device 1 by an optical measurement as achieved with a laser vibrometer. Within the scope of such an alternative, it is not necessary to integrate any measuring system in the base of the lever. Such optical measurements of the vibration amplitude of a vibrating surface are known in prior art, thus they are not described herein in further detail.

Typically, the lever of a substrate 20 has the following characteristic dimensions:
a length between 5 and 2 000 micrometres,
a width between 5 and 1 000 micrometres, and
a thickness between 500 nanometres and 200 nanometres.

This lever is preferentially made of diamond but can also be made of another material such as silicon carbide, tungsten carbide, silicon nitride, or even silicon. Diamond is however to be preferred since it enables the surface of the lever to be functionalised without requiring the use of a bond layer, such as a gold layer, to make such a surface functionalisation. Furthermore, diamond because of its high Young modulus, enables the vibrating surface to be provided with particularly high resonance frequencies and also high quality factors for this resonance, which enables a good sensitivity to be obtained within the scope of the detection of chemical compounds.

The surface of each of the vibrating surfaces 21 is preferentially functionalised such that each of the vibrating surfaces 21 is particularly sensitive to a chemical compound or a family of chemical compounds. Thus, for example, within the scope of a use of a device 1 for detecting drugs, the vibrating surfaces 21 can be functionalised to interact with the presence of drugs, their precursors and/or their degradation products in a gaseous medium such as, for example, opiates, cocaine, cannabinoids, or even amphetamines. Within the scope of a use as a DNA chip, each of the vibrating surfaces can be functionalised to interact with a gene or a predefined gene portion. Furthermore, the device can also be suitable for enabling environmental analyses such as analyses for the air or water quality, the vibrating surfaces being therefore functionalised for interacting with some pollutants or pollution markers.

Of course, if the substrates 20 according to this embodiment comprise a vibrating surface 21 as a lever, it can also be contemplated, without departing from the scope of the invention, that the substrate integrates another type of vibrating surface, such as for example vibrating bridges or vibrating membranes, or even as a more complex shape than that of a simple lever, by including, for example, a circular, or square platform, the width of which is higher than that of the lever base.

When the substrates 20 are placed to their dedicated locations in the analysis chamber, the substrates 20 are therefore in mechanical contact with the analysis chamber 13 which is itself in mechanical contact with the piezoelectric actuator 12. Thus, any mechanical wave generated by the mechanical actuator will be transmitted to the analysis chamber 13 and to the substrates 20 located in the analysis chamber 13. The vibrating surfaces 21 will thus be also subjected to the mechanical wave. The mechanical wave thus transmitted to the vibrating surfaces, if its frequency is coincident with the resonance frequency of some vibrating surfaces, excites the resonant vibration mode of these vibrating surfaces and thus vibrates them.

With such a configuration of the cell, the piezoelectric actuator forms an actuating system suitable for generating a mechanical wave remote from the vibrating surfaces 21 and the arrangement of which enables the mechanical wave to be transmitted to the vibrating surfaces 21 to vibrate it.

The analysis chamber 13 is in fluid communication with the feed duct 15 thus allowing the introduction of the chemical composition into the analysis chamber through said duct. Likewise, in order to extract the chemical composition after analysis, the chamber is in fluid communication with the removal duct 16.

The cap illustrated in FIG. 2 is suitable for hermetically close the analysis chamber 13 while allowing an electrical connection of the substrates 20 with the outside of the cell 10 to a processing unit, not illustrated.

The hermeticity of closing the analysis chamber 13 by the cap 14 is achieved, as illustrated in FIG. 2, by means of an O-ring 17 sandwiched between the cap 14 and the analysis chamber 13. As regards the electrical communication of the substrates 20 with the outside of the cell 10, the cap includes, as illustrated in FIGS. 4a, b and c, passageways for connectors 18, which is represented in FIG. 4c by solid lines. These connectors 18 for facilitating contacting on substrates 20, are preferentially spring connectors so as to enable contacting on the substrates by a simple placement of the cap 14 which causes them to bear against contact surfaces provided on the substrates 20.

So as to ensure hermeticity of the cap 14, the passageways of the connectors are preferentially filled, after setting up the spring connectors 18 and as illustrated in FIG. 4c, through a tight-filling material 19, such as a glue. Such a filling material 19, as well as the inner surface of the cap forming an inner wall of the chamber when the cell is closed, are preferentially neutral, or made neutral relative to the chemical compounds to be analysed.

In the case where the measurement of the vibration amplitude of each of the vibrating surfaces 21 is made optically, the cap has a shape suitable for such a measurement. FIG. 5 illustrates a cross-section view of a cap 14 having such a shape. Indeed, so as to allow the measurement, the cap includes a centre wall 14a at least partially transparent to the wavelength to which the amplitude measurement is made.

The device 1 is suitable for being connected to a control unit. The control unit is configured to control the piezoelectric actuator and perform the measurement of the resonance frequency of the vibrating surfaces so as to detect and/or measure out at least one chemical compound in a chemical composition.

The control unit is configured to implement the method for detecting and/or measuring out at least one chemical compound including the following steps of:
introducing into the cell a chemical composition to be analysed which is likely to include at least one chemical compound to be detected and/or measured out so as to interact with said chemical compound with the corresponding vibrating surface,
implementing the piezoelectric actuator so as to apply a mechanical wave by sweeping its frequency on a frequency range in which the resonance frequencies of the vibrating surfaces are included regardless of whether they have reacted with a chemical compound,
measuring during the implementation of the piezoelectric actuator 12 the vibration amplitude so as to detect the resonance frequency of each of the vibrating surfaces 21,
analysing the variations in resonance frequency of each of the vibrating surfaces 21 so as to determine whether at least one vibrating surface 21 has interacted with one or more chemical compounds and in which proportion,
determining from the analysis of the variations in the resonance frequencies of the vibrating surfaces 21 a detection of at least one of the one or more chemical compounds to be detected and/or measured out, and, possibly, the amount of chemical compound present in the chemical composition.

According to a possibility of the invention, the processing unit can also be configured to make a first calibration step prior to the analysis of the chemical composition. Such a prior calibration step can include the substeps of:
implementing the piezoelectric actuator 12, so as to apply a mechanical wave by sweeping its frequency on a frequency range in which the resonance frequencies of the vibrating surfaces 21 are included without interacting with any chemical compound,
measuring during the implementation of the piezoelectric actuator 12 the vibration amplitude so as to detect the resonance frequency of the vibrating surfaces 21,
correcting the reference resonance frequency of each vibrating surface 21 from the determined value during the measuring substep so as to use this value to determine the frequency offset during the rest of the analysis procedure.

Such a calibration step is also particularly interesting in the case where the arrangement of the piezoelectric actuator 12 relative to the locations of the substrates 20 does not enable the mechanical wave to be transmitted to all the vibrating surfaces 21 with the same power.

If in the embodiment above, the device 1 includes a cell 10 which comprises the piezoelectric actuator 12, and a plurality of substrates 20 each including a vibrating surface 21, it can also be contemplated, without departing from the scope of the invention, that the device 1 includes a single substrate 20 on which an actuating system and the vibrating surfaces 21 are integrated. Likewise, it can also be contemplated, outside the scope of the invention, that the device includes a plurality of substrates each including an actuating system and a vibrating surface, said actuating system being dedicated to the vibrating surface located on the same substrate, and an equal number of vibrating surfaces or even a single substrate including a plurality of actuating systems and vibrating surfaces.

It can also be noted that if in the embodiment, the transmission of the mechanical wave generated by the piezoelectric actuator to each of the vibrating surfaces 21 is made by a mechanical contact between the piezoelectric actuator 12 and the analysis chamber 13 and between the analysis chamber 13 and each of the substrates 20, it can be contemplated, without departing from the scope of the invention, that the transmission of the mechanical wave is acoustically made. Thus, the piezoelectric actuator 12 could be disposed in the chamber 10 remote from the substrates 20 without mechanical contact with the same, the mechanical wave being transmitted by an acoustic wave through the fluid located in the analysis chamber 13. This possibility of the invention is particularly adapted to the case where the chemical composition to be analysed is a liquid solution.

1-9. (canceled)

10. A device for detecting and/or measuring out one or more chemical compounds, the device comprising:
at least one first and one second vibrating surface, each of the first and the second vibrating surfaces having a resonance frequency which varies when placed in presence of at least one chemical compound to be detected;
at least one first actuating system of the first vibrating surface configured to vibrate the first vibrating surface;
wherein the first actuating system is configured to generate a first mechanical wave remote from the first and the second vibrating surfaces, the first actuating system arranged in the device such that the first mechanical wave is transmitted to the first and the second vibrating surfaces to vibrate the first and the second vibrating surfaces.

11. The device according to claim 10, wherein arrangement of the first actuating system relative to the first and the second vibrating surface is configured so that power of the mechanical wave transmitted to the first and to the second vibrating surfaces is substantially equal.

12. The device according to claim 10, further comprising:
a cell in which a chemical composition comprising at least one chemical compound to be detected can be introduced;
at least one first and one second substrate of vibrating surface disposed in the cell, the first and the second substrates including the first and the second vibrating surfaces respectively.

13. The device according to claim 10, further comprising:
a cell in which a chemical composition comprising at least one chemical compound to be detected can be introduced;
at least one substrate of vibrating surface disposed in the cell, the substrate including at least the first and the second vibrating surfaces.

14. The device according to claim 12, wherein the cell includes the first actuating system.

15. The device according to claim 14, wherein the first actuating system is a piezoelectric actuator.

16. The device according to claim 13, wherein the cell includes the first actuating system.

17. The device according to claim 16, wherein the first actuating system is a piezoelectric actuator.

18. The device according to claim 13, wherein the substrate includes the first actuating system.

19. The device according to claim 10, wherein at least the first vibrating surface is made of diamond.

20. A cell for use in a device according to claim 12, wherein a chemical composition comprising at least one chemical compound to be detected can be introduced, the cell including at least one first and one second location to accommodate a first and a second substrate of vibrating surface respectively including a first and a second vibrating surface respectively, each of the first and second vibrating surfaces having a resonance frequency which varies when placed in presence of at least one chemical compound to be detected,
the cell further comprising at least one first actuating system configured to generate a first mechanical wave remote from the first and the second location, the first actuating system being arranged in the cell such that the first mechanical wave is transmitted to the first and the second vibrating surfaces to vibrate the first and the second vibrating surfaces when the first and the second substrates of vibrating surface are accommodated in the first and the second locations.
